(19) United States
(12) Patent Application Publication
(10) Pub. No.: US 2017/0256873 A1
(43) Pub. Date: Sep. 7, 2017

(54) METHOD AND APPARATUS FOR PROVIDING ELECTRICAL POWER TO A CIRCUIT

(71) Applicant: JST Performance, LLC, Gilbert, AZ (US)

(72) Inventor: Westin C. Knop, Chandler, AZ (US)

(73) Assignee: JST Performance, LLC, Gilbert, AZ (US)

(21) Appl. No.: 15/430,701

(22) Filed: Feb. 13, 2017

Related U.S. Application Data
(60) Provisional application No. 62/304,395, filed on Mar. 7, 2016.

(51) Int. Cl. H01R 12/71; H01R 12/70

(52) U.S. Cl. CPC H01R 12/716; H01R 12/7088; H01R 12/7076

(57) ABSTRACT

A barrel type power terminal electrically coupled to a top side of a printed circuit board (PCB) with a barrel portion extending through or capable of receiving power through one of an aperture and a slot to a bottom side of the PCB. The terminal may have one or more leads, each lead electrically connected with a different pin or barrel segment of the barrel portion. A plug may interconnect with the barrel portion on the bottom side of the PCB. The terminal may be held in place by the one or more leads connected to pads of the PCB and/or by an insert.

### FIELD OF THE INVENTION

The present invention generally relates to power terminals, and more particularly to barrel jack type power terminals.

### BACKGROUND

Power terminals are frequently used to provide power to electrical circuits. Electrical circuits may be contained on a printed circuit board (PCB). Additionally the PCB may be a metal clad printed circuit board (MCPCB). Depending on the specific configuration and orientation of the PCB, power may need to be provided to the PCB from a particular direction.

Power terminals may come in a particular size. Generally, at least one side of the power terminal is configured to contact the PCB. The contacting side creates a footprint on the PCB that is unavailable for other components of the electrical circuit. Furthermore, a power terminal has one or more conductors, or leads. In general, the greater the number of conductors, the greater the size of the power terminal, and the greater the footprint required on the PCB.

Efforts continue, therefore, to develop power terminals that enable power to be provided from a particular direction, while minimizing the footprint on the PCB.

### SUMMARY

A power terminal may be connectable to a surface. The power terminal may include one or more leads, where each lead is capable of electrically contacting the surface. The power terminal may further include one or more barrel segments, where each segment is in electrical communication with a different one of the one or more leads. Further, at least one barrel segment may extend below the surface.

A barrel jack may be electrically connectable to a PCB. The barrel jack may include one or more leads, where each lead contacts corresponding pads on a first side of the PCB. The power terminal may further include one or more barrel segments, where each segment is in electrical communication with a different one of the one or more leads. Further, at least one barrel segment may extend to a second side of the PCB.

A method may include providing power to either a pin or to a barrel segment of a barrel type power terminal located on a second side of a PCB. The power may be passed to a lead located on a first side of the PCB. The power may be transferred to a first pad of the PCB located on a first side of the PCB.

### BRIEF DESCRIPTION OF THE DRAWINGS

Various aspects and advantages of the invention will become apparent upon review of the following detailed description and upon reference to the drawings in which:

FIG. 1 illustrates a power terminal in accordance with one embodiment of the present invention;

FIG. 2 illustrates a power terminal in accordance with another embodiment of the present invention;

FIG. 3 illustrates a power terminal in accordance with another embodiment of the present invention;

FIG. 4 illustrates a power terminal in accordance with another embodiment of the present invention;

FIG. 5 illustrates a power terminal in accordance with another embodiment of the present invention;

FIG. 6 illustrates a power terminal in accordance with another embodiment of the present invention;

FIG. 7 illustrates a power terminal in accordance with another embodiment of the present invention;

### DETAILED DESCRIPTION

A power terminal may be used to provide electrical power to a printed circuit board (PCB). The power terminal may be of the barrel type and may be configured to receive direct current (DC) power. Furthermore, the power terminal may be configured to be utilized from the bottom of the PCB. The power terminal may have one or more leads, one or more rings, one or more pins, and/or one or more barrel segments.

In a specific example, a single lead power terminal may include at least one lead and one pin or barrel segment. Power may be received by the pin or barrel segment and passed to the lead. In another specific example, a single lead power terminal may include one lead, one ring, and one pin or barrel segment. Power may be received by the pin or barrel segment and passed to the lead via the ring. The PCB may receive power from the lead via a pad.

Further, in a more complex power terminal (i.e., two or more leads), there may be a corresponding ring for every lead, and/or there may be a corresponding pin or barrel segment for every lead. Each lead, ring, and pin or barrel segment form a component set. Each set may be electrically isolated from every other component set by a non-electrically-conductive material.

A plug may be shaped to interconnect with the power terminal, such that corresponding contacts of the plug electrically contact one of either a pin or a barrel segment. For example, where a power terminal includes a pin and a barrel segment, a plug may include a first contact which electrically contacts the pin and a second contact which electrically contacts the barrel segment. A person of ordinary skill in the art will appreciate that a power terminal having more pins or more barrel segments may operate according to the same principles.

The power terminal may be electrically connected to a first side of the PCB. The power terminal may be accessible from a second side of the PCB. For example, the power terminal may extend through an aperture or a slot in the PCB, such that the plug may be interconnected to the power terminal beyond the second side of the PCB.

The power terminal may be fixed with respect to the PCB by means of the leads (e.g., by soldering), or by the use of an insert, or both. Furthermore, the insert may insulate the power terminal from the PCB, except where electrical connection is intended by the leads.

Thus, the present invention enables power to be supplied to a power terminal from a side of the PCB that is opposite, or behind, the other components of the circuit (e.g., the second side). Providing power from behind the PCB may be necessitated by environmental conditions. For example, such a situation arises where the circuit contains LEDs which emit light away from the first side of the PCB, but it is more convenient to connect power to the circuit from behind the PCB (e.g., in a light fixture).

Furthermore, the use of a barrel type power terminal in the present configuration may enable the PCB to be kept small. Various other power terminals may require an increasingly larger footprint to accommodate higher numbers of electrical leads. However, the barrel type power terminal may only require an increase in the length of a barrel portion of the power terminal, not an increase in the size of the footprint on the PCB. Accordingly a PCB may be kept small, while enabling the versatility of many paths for power flow (e.g., from each component set to the electrical circuitry on the PCB).

Furthermore, the use of a barrel type power terminal eliminates the need for a specific orientation for proper interconnection of the plug with the power terminal.

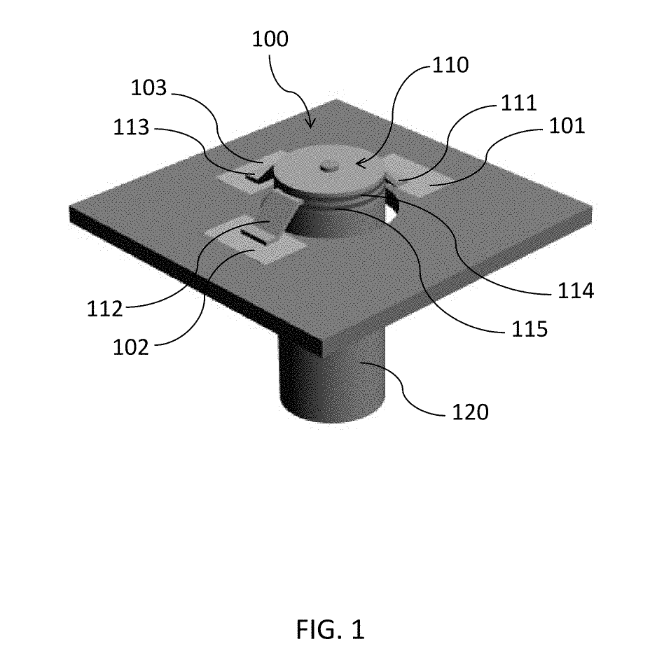

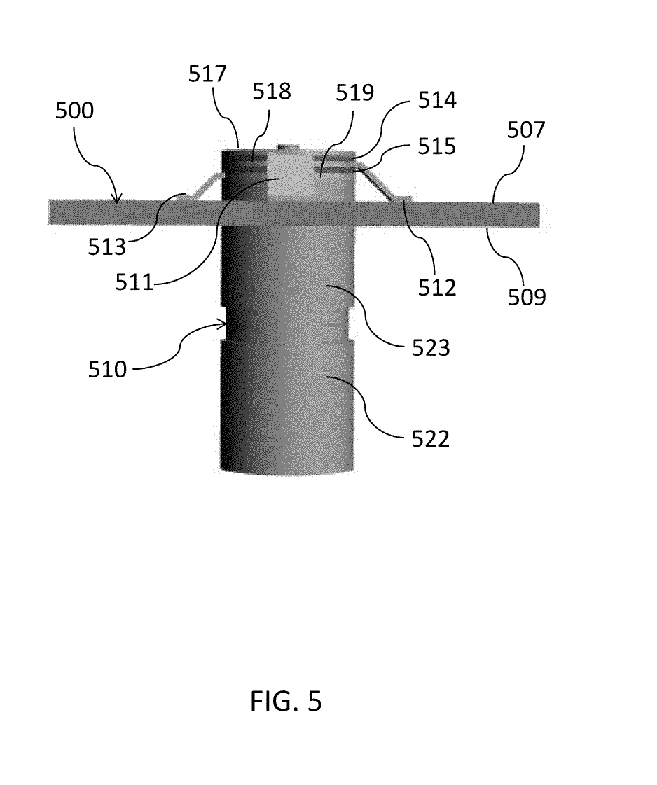

As illustrated in FIG. 1, a barrel jack 110 may provide power to a PCB 100. The barrel jack 110 may have one or more electrical leads (e.g., leads 111, 112, 113). The one or more leads may be electrically isolated by non-conductive material (e.g., layers 114, 115). The leads may be in electrical contact with one or more pads of the PCB 100 (e.g., pads 101, 102, 103). For example, the leads may be soldered to the pads. In another example, the pads of the PCB 100 may be positioned on an upper surface (e.g., first side 507 of FIG. 5) of PCB 100.

The barrel jack 110 may also include a barrel portion 120 extending away from PCB 100. For example, barrel portion 120 may extend beyond a lower surface (e.g., second side 509 of FIG. 5) of PCB 100, and/or oppositely of the first surface. The non-conductive material may extend through the barrel portion 120 to maintain the electrical isolation of the one or more leads. Power may be provided from a plug (not shown). The plug may be shaped to interconnect with the barrel portion 120 of the barrel jack 110. The power provided to the barrel portion 120 may be passed to any one of the one or more pads of the PCB 100 via any one of the one or more leads.

Although not shown or described in the present invention, a person of ordinary skill in the art will appreciate that the one or more pads may be incorporated into any circuit, to enable power to be provided to that circuit as needed for the operation thereof. For example, while pads 101, 102, 103 have been illustrated as simple rectangular electrical pads, a person of ordinary skill in the art will appreciate that power may be passed to a pad comprising any type or form of electrical component on the PCB, including, but not limited to a capacitor, resistor, fuse, transistor, transformer, diode, transducer, sensor, connector, cable, switch, or any other known electrical component.

The leads may further provide structure to the barrel jack 110. Accordingly, the one or more leads may enable the barrel jack 110 to be held in a fixed relationship with the PCB 100 when attached to the pads. The connection between the leads and the pads may be strong enough to prevent movement of the barrel jack 110 during coupling and decoupling of the plug. The connection may also resist movement caused while the plug is interconnected due to environmental factors (e.g., tugging on a cable, not shown, extending from the plug).

While the leads are illustrated in roughly ninety degree increments around a circumferential perimeter of the barrel jack 110, this configuration is not essential. Depending on the size of the leads and corresponding pads of PCB 100, the angular spread between each lead may be small (e.g., 10 degrees), or large (e.g., 270 degrees). Furthermore, a system may have more or less leads than that illustrated in FIG. 1 (e.g., 1, 2, 3, 4, 5, or more leads). A person of ordinary skill in the art will appreciate that a system having more leads will require a smaller average angular spread between each lead around a circumference of the barrel jack 110.

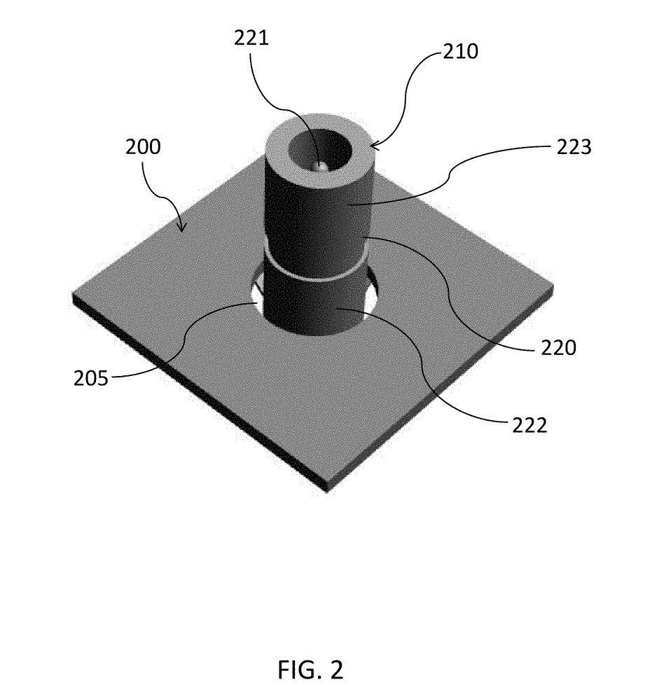

As illustrated in FIG. 2, a barrel jack 210 may extend below an undersurface (e.g., second side 509 of FIG. 5) of a PCB 200 (e.g., through an aperture 205 of a PCB 200). The barrel jack 210 may include a barrel portion 220. The barrel portion 220 may include one or more discrete electrical contacts (e.g., a pin 221, and one or more barrel segments 222, 223). The discrete electrical contacts may be electrically isolated by non-conductive material (e.g., layers 514, 515 of FIG. 5).

The non-conductive material of FIG. 2 may correspond, or interconnect, with the non-conductive material of FIG. 1. Furthermore, the one or more discrete electrical contacts of the barrel portion 220 may each correlate with one or more leads of the barrel jack 210 (e.g., leads 111, 112, 113 of FIG. 1). For example, pin 221 may be in electrical contact with a first lead (e.g., lead 111 of FIG. 1), and so on.

Although FIG. 2 illustrates a pin and two barrel segments, a barrel jack having three leads could be configured with three corresponding barrel segments, or with two pins and one barrel segment. A person of ordinary skill in the art will appreciate that many combinations of pins and barrel segments are possible, and may be optimized to minimize the footprint of barrel jack 210 on PCB 200 (e.g., the amount of surface area of PCB 200 occupied by barrel jack 210).

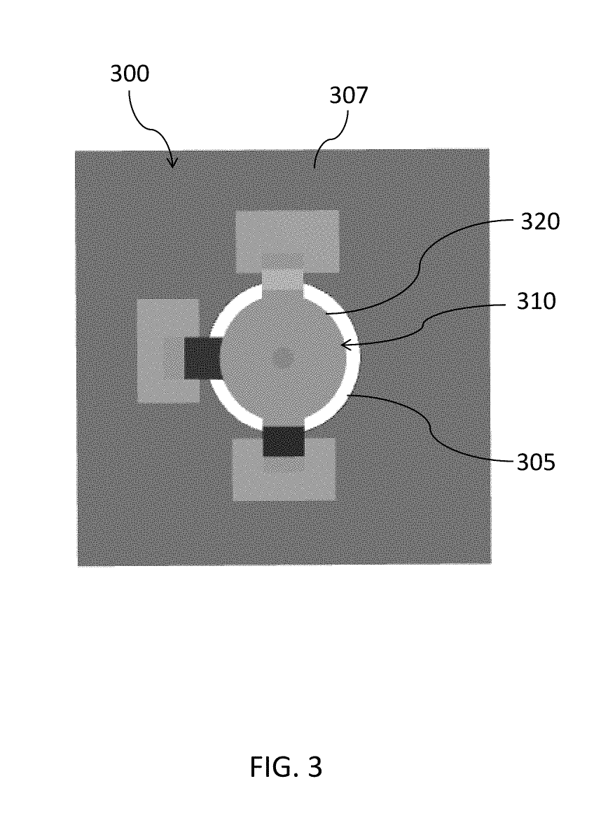

As illustrated in FIG. 3, a barrel jack 310 may be aligned with an aperture 305 of a PCB 300. Where the PCB 300 is a metal clad printed circuit board (MCPCB), the barrel jack 310 may be positioned to be spaced away from the edge of aperture 305 (e.g., to prevent unintentional grounding of the circuit).

Barrel jack 310 may be in electrical contact with a circuit visible on a first side 307 of the PCB 300. Barrel jack 310 may extend above first side 307 (e.g., as illustrated in FIG. 1). Although not shown, a barrel portion 320 of the barrel jack 310 may not extend below the first side 307 of the PCB 300 (e.g., a plug, not shown, may extend through the aperture 305 to interconnect with the barrel portion 320, from below first side 307, such that the plug extends through PCB 300).

Alternatively, barrel portion 320 may extend through aperture 305 to a second side (e.g., second side 509 of FIG. 9) of PCB 300. In yet another alternative, barrel portion 320 may extend through the aperture 305 and beyond the second side of PCB 300 (e.g., as illustrated in FIG. 1). Barrel portion 320 may extend far enough that a plug (not shown) does not pass through aperture 305 during interconnection with barrel portion 320.

Aperture 305 may be any suitable shape. For example, and without limitation, the aperture may be square, rectangular, circular, triangular, or any other suitable shape to permit placement of the barrel jack 310 either partially or completely through the aperture, or at or above the aperture.

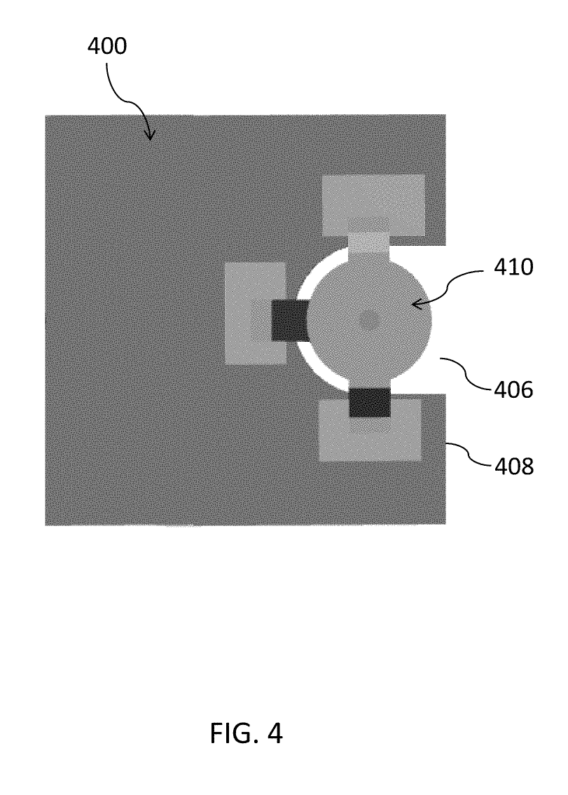

As illustrated in FIG. 4, a barrel jack 410 may be aligned with a slot 406 of a PCB 400. Slot 406 may be cut or otherwise formed in a perimeter edge 408 of PCB 400. The use of slot 406, rather than an aperture (e.g., as illustrated with respect to aperture 305 of FIG. 3), may be advantageous where fewer leads are provided in barrel jack 410, or where placement near the perimeter of the PCB is necessitated by environmental factors (e.g., ease of use by a user).

Slot 406 may be any suitable shape. For example, and without limitation, the slot may be square, rectangular, circular, triangular, or any other suitable shape to permit placement of the barrel jack 410 either partially or completely within the slot.

As illustrated in FIG. 5, a barrel jack 510 may extend through a PCB 500 from a first side 507 to a second side 509. Barrel jack 510 may include a first lead 511, a second lead 512, and a third lead 513. Each lead may be in electrical contact with a corresponding pad of the PCB 500 (e.g., pads 101, 102, 103 of FIG. 1).

Barrel jack 510 may include one or more rings (e.g., rings 517, 518, 519), each corresponding to leads 511, 512, 513. For example, ring 517 may be in electrical contact with lead 511, ring 518 may be in electrical contact with lead 512, and ring 519 may be in electrical contact with lead 513. The rings may be electrically isolated from each other by a non-conductive material (e.g., layers 514, 515).

Barrel jack 510 may include a first pin (e.g., pin 221 of FIG. 2), a first barrel segment 522, and a second barrel segment 523. The first pin, first barrel segment, and second barrel segment may correspond to the rings 517, 518, 519. For example, the first pin may be in electrical contact with ring 517, the first barrel segment may be in electrical contact with ring 518, and the second barrel segment may be in electrical contact with ring 519. The pin and barrel segments may be electrically isolated from each other by a non-conductive material (e.g., layers 514, 515).

Thus, in one embodiment of the present invention, power from a power source may be provided to any of the pin or barrel segments 522, 523, and that power may be transferred to corresponding pads of PCB 500 via corresponding rings and lead of the barrel jack 510. While this embodiment has been illustrated in terms of a pin and two barrel segments, a person of ordinary skill in the art will appreciate that more or less pins may be used, that more or less barrel segments may be used, and that more or less leads may be used to optimize power transfer between the power source and PCB 500.

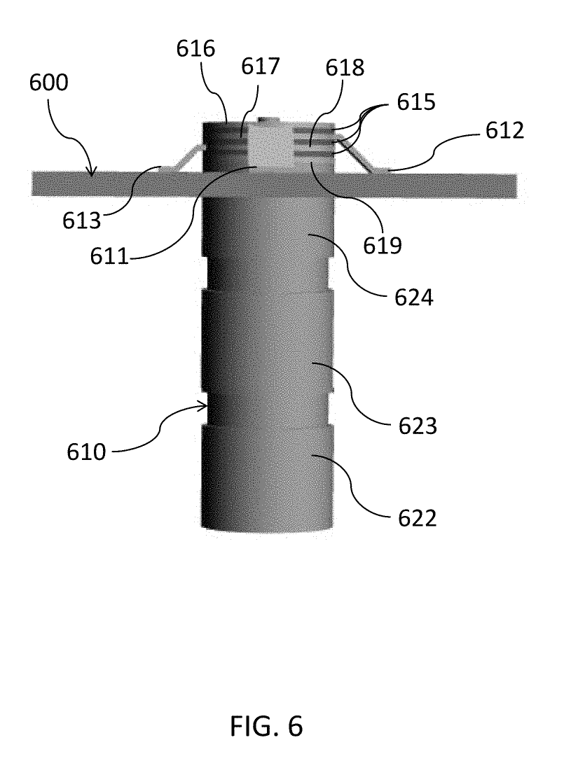

As illustrated in FIG. 6, a barrel jack 610 may include a first lead 611, a second lead 612, a third lead 613, and a fourth lead (not shown, e.g., disposed oppositely of first lead 611 across barrel jack 610). Each lead may be in electrical contact with a corresponding pad (not shown) of a PCB 600. Further, each lead may be in electrical contact with a corresponding ring of the barrel jack 610 (e.g., rings 516, 517, 518, and 519). Further, each ring may be in electrical contact with a corresponding pin (not shown), or barrel segment (e.g., barrel segments 622, 623, 624).

In a first example, power may be transferred from the pin (not shown) to ring 616, then to lead 611, then to a corresponding pad of the PCB 600. In a second example, power may be transferred from a first barrel segment 622 to ring 617, then to lead 612, then to a corresponding pad of the PCB 600. In a third example, power may be transferred from a second barrel segment 623 to ring 618, then to lead 613, then to a corresponding pad of the PCB 600. In a fourth example, power may be transferred from a third barrel segment 624 to ring 619, then to the fourth lead (not shown), then to a corresponding pad of the PCB 600.

While power has been described in particular embodiments as passing in a particular direction, a person of ordinary skill in the art will appreciate that power in any of the above embodiments may flow in the opposite direction as that specifically discussed without departing from the scope of the present invention.

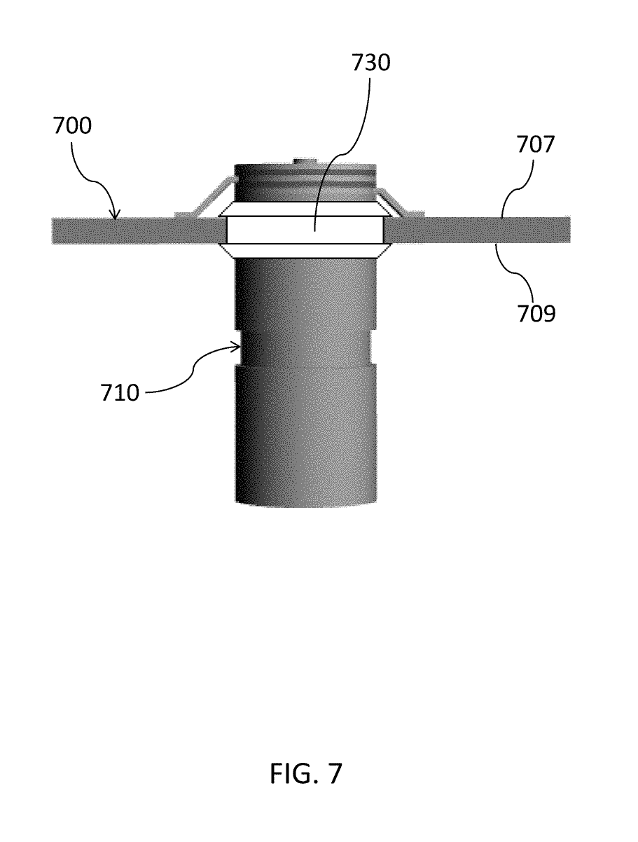

As illustrated in FIG. 7, a barrel jack 710 may be affixed to a PCB 700 by means of an insert 730. Insert 730 may be configured to partially or entirely encircle, or enclose, an outer perimeter of barrel jack 710. For example, insert 730 may be fitted to the perimeter of barrel jack 710 prior to installation of barrel jack 710 to PCB 700 (e.g., friction fitted, snap fitted, or otherwise attached). Further, insert 730 may be configured to partially or entirely encircle an inner perimeter of the aperture and/or slot (e.g., aperture 305 of FIG. 3, or slot 406 of FIG. 4) of PCB 700 prior to installation of the barrel jack 710 to PCB 700 (e.g., friction fitted, snap fitted, or otherwise attached).

Insert 730 may be formed of a non-conductive material, and may serve to insulate a side-wall of barrel jack 710 from making electrical or any other kind of direct contact with PCB 700. This feature may be particularly suited to the use of MCPCBs.

Furthermore, insert 730 may have surface features which enable or assist in maintaining barrel jack 710 in a fixed relationship with respect to PCB 700. For example, insert 730 may entirely fill a gap between barrel jack 710 and PCB 700. Further, insert 730 may extend around a top surface 707 and/or a bottom surface 709 (e.g., with flanges).

Further, insert 730 may be formed as one continuous part, or as two or more parts. For example, where insert 730 is formed as two or more parts, each part may be interconnected before or during attachment to either PCB 700 or barrel jack 710. In another example, the two or more parts may be separately attached to PCB 700 or barrel jack 710, or both.

Other aspects and embodiments of the present invention will be apparent to those skilled in the art from consideration of the specification and practice of the invention disclosed herein. It is intended, therefore, that the specification and illustrated embodiments be considered as examples only, with a true scope and spirit of the invention being indicated by the following claims.

What is claimed is:

1. A power terminal connectable to a surface, the power terminal comprising:
one or more leads capable of electrically contacting the surface; and
one or more barrel segments, each segment in electrical communication with a different of the one or more leads;
wherein at least one barrel segment extends below the surface.

2. The power terminal of claim 1, wherein the one or more leads are in electrical communication with pads of the surface.

3. The power terminal of claim 1, further including one or more pins, each pin in electrical communication with a different of the one or more leads.

4. The power terminal of claim 3, wherein at least one of the one or more pins extends below the surface.

5. The power terminal of claim 1, wherein at least one barrel segment extends through an aperture in the surface.

6. The power terminal of claim 1, wherein at least one barrel segment extends through a slot in the surface.

7. The power terminal of claim 1, further including an insert capable of stabilizing the power terminal with respect to the surface.

8. The power terminal of claim 1, wherein the one or more barrel segments extend perpendicularly to the surface.

9. A barrel jack electrically connectable to a PCB, the barrel jack comprising:
one or more leads contacting corresponding pads on a first side of the PCB; and
one or more barrel segments, each segment in electrical communication with a different of the one or more leads;
wherein the one or more barrel segments are connectable to a power source from a second side of the PCB.

10. The barrel jack of claim 9, further including one or more pins, each pin in electrical communication with a different of the one or more leads.

11. The barrel jack of claim 10, wherein the one or more pins includes one pin, and wherein the one or more barrel segments includes two barrel segments.

12. The barrel jack of claim 10, wherein at least one of the one or more pins are connectable to a power source from the second side of the PCB.

13. The barrel jack of claim 10, wherein each of the one or more pins and each of the one or more barrel segments are in electrical communication with a different of the one or more leads.

14. The barrel jack of claim 13, wherein each of the one or more leads are in electrical communication with different pads of the PCB.

15. The barrel jack of claim 9, wherein the one or more barrel segments are positioned above the first side of the PCB and do not extend from the first side to the second side of the PCB.

16. The barrel jack of claim 9, wherein at least one barrel segment extends to the second side of the PCB.

17. The barrel jack of claim 9, wherein at least one barrel segment extends from the first side to the second side and beyond the second side of the PCB.

18. A method, comprising:
providing power to at least one of a pin and a barrel segment of a barrel type power terminal from a second side of a PCB;
passing power to first lead located on a first side of the PCB; and
transferring power to a first pad of the PCB located on a first side of the PCB.

19. The method of claim 18, further including passing power to a second pad of the PCB via a second lead of the barrel type power terminal, the second pad located on the first side of the PCB.

20. The method of claim 19, further including passing power to a third pad of the PCB via a third lead of the barrel type power terminal, the third pad located on the first side of the PCB.
